(19) United States
(12) Patent Application Publication
(10) Pub. No.: US 2012/0106784 A1
(43) Pub. Date: May 3, 2012

(54) APPARATUS AND METHOD FOR TRACKING OBJECT IN IMAGE PROCESSING SYSTEM

(75) Inventors: Ik-Hwan Cho, Suwon-si (KR); Dae-Kyu Shin, Suwon-si (KR); Chang-Sung Jung, Seoul (KR); Min-Seok Ku, Seoul (KR); Jin-Hyung Park, Seo-gu (KR); Dong-Hwan Seo, Seoul (KR)

(73) Assignees: KOREA UNIVERSITY RESEARCH AND BUSINESS FOUNDATION, Seoul (KR); SAMSUNG ELECTRONICS CO., LTD., Suwon-si (KR)

(21) Appl. No.: 13/204,289

(22) Filed: Aug. 5, 2011

(30) Foreign Application Priority Data
Oct. 28, 2010 (KR) 10-2010-0105770

(51) Int. Cl. G06K 9/00

(52) U.S. Cl. 382/103

(57) ABSTRACT

A method, apparatus, and system track an object in an image or a video. Pose information is extracted using a relation of at least one feature point extracted in a first Region of Interest (RoI). A pose is estimated using the pose information. A secpmd RoI is set using the pose. And the second RoI is estimated using a filtering scheme.

### CROSS-REFERENCE TO RELATED APPLICATION(S) AND CLAIM OF PRIORITY

The present application is related to and claims the benefit under 35 U.S.C. §119(a) to a Korean patent application filed in the Korean Intellectual Property Office on Oct. 28, 2010, and assigned Ser. No. 10-2010-0105770, the entire disclosure of which is hereby incorporated by reference.

### TECHNICAL FIELD OF THE INVENTION

The present invention relates generally to an image processing system. More particularly, the present invention relates to an apparatus and a method for tracking an object in an image or a video input through a camera in an image processing system.

### BACKGROUND OF THE INVENTION

Object tracking technology recognizes a particular object in a still image or a video and detects a movement and a pose; that is, a viewed angle of the object. The object tracking technology can be used for various purposes. For example, the object tracking technology can be applied to implement augmented reality for drawing attention to and tracking a movement path of a vehicle or a person in an image captured by a surveillance camera.

In brief, the object tracking process extracts feature points in the image, recognizes the object by detecting the same feature points as the feature points of the target object, and then estimates location and angle information of the object using coordinate information of the feature points. The object tracking process extracts the feature points from two images according to the time and determines where the object is headed according to movement information of similar feature points with respect to time.

Conventional object tracking methods using the entire image degrade a feature point extraction speed and are subject to error in pose information extraction due to inaccurate feature point detection. In this regard, a method for narrowing the range of the feature point search by setting part of the image as a Region of Interest (RoI) is suggested. However, this method cannot handle the situation of the image because the RoI setting is fixed, to thus deteriorate accuracy.

Therefore, the object tracking in the image needs a method for adaptively setting the RoI according to the situation of the image and enhancing the object tracking performance.

### SUMMARY OF THE INVENTION

To address the above-discussed deficiencies of the prior art, it is a primary aspect of the present invention to provide an apparatus and a method for enhancing accuracy for a Region of Interest (RoI) in an image processing system.

Another aspect of the present invention is to provide an apparatus and a method for adaptively setting an RoI according to a situation of an image in an image processing system.

Another aspect of the present invention is to provide an apparatus and a method for improving a processing speed and accuracy by setting an RoI using pose information estimated in an image processing system.

Yet another aspect of the present invention is to provide an apparatus and a method for improving accuracy for an RoI by estimating the RoI using a previous RoI in an image processing system.

According to one aspect of the present invention, a method for tracking an object in an image is provided. Pose information is extracted using a relation of at least one feature point extracted in a first RoI. A pose is estimated using the pose information. A second RoI is set using the pose. And the second RoI is estimated using a filtering scheme.

According to another aspect of the present invention, an apparatus for tracking an object in an image is provided. The apparatus includes an image information generator and an operator. The image information generator generates image information. The operator extracts pose information using a relation of at least one feature point extracted in a first RoI, estimates a pose using the pose information, sets a second RoI using the pose, and estimates the second RoI using a filtering scheme.

According to yet another aspect of the present invention, system for tracking an object in an image is provided. The system includes an image processing system for extracting pose information using a relation of at least one feature point extracted in a first Region of Interest (RoI), estimating a pose using the pose information, setting a second RoI using the pose, and estimating the second RoI using a filtering scheme

Other aspects, advantages, and salient features of the invention will become apparent to those skilled in the art from the following detailed description, which, taken in conjunction with the annexed drawings, discloses embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a process for tracking an object in an image processing system according to an embodiment of the present invention;

FIG. 2 illustrates a process for setting an RoI in the image processing system according to an embodiment of the present invention; and

FIG. 3 is a block diagram of the image processing system according to an embodiment of the present invention.

Throughout the drawings, like reference numerals will be understood to refer to like parts, components and structures.

### DETAILED DESCRIPTION OF THE INVENTION

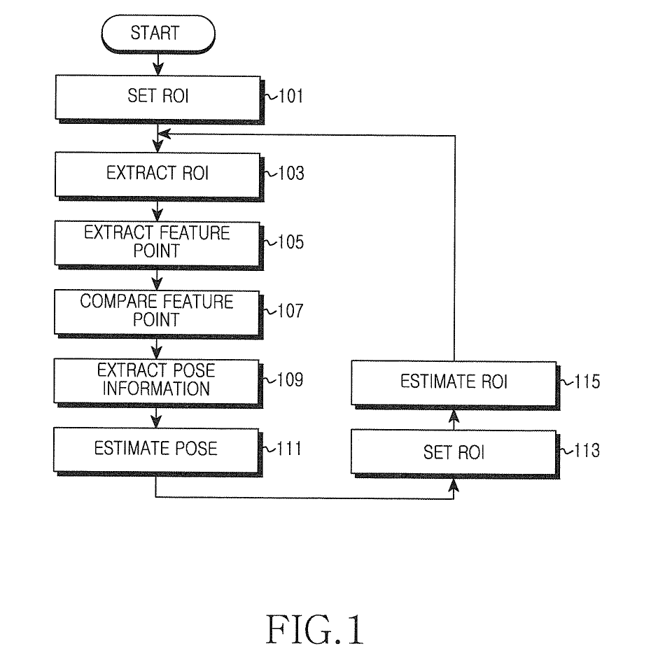

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitable system.

Embodiments of the present invention provide a technique for enhancing an object tracking performance by effectively setting a Region of Interest (RoI) in an image processing system. Herein, the image processing system represents an apparatus capable of receiving an image or a video, analyzing the image or the video, and recognizing a particular object in the image or the video. For example, the image processing system can employ image display apparatuses such as a portable terminal, a lap-top computer, a desktop computer, a smart TV, and such.

The present invention extracts feature points from an image input through a camera or pre-stored, determines corresponding feature points by comparing the extracted feature points with predefined feature points of a target object, obtains pose information such as location and angle of the object using relation between coordinates of the corresponding feature points, determines an actual location by robustly estimating the pose information, sets an RoI using the pose information and a previous RoI, and repeats these operations within the RoI.

FIG. 1 illustrates process for tracking an object in an image processing system according to an embodiment of the present invention.

Referring to FIG. 1, the image processing system sets an RoI in an image extracted from a video input through a camera or a pre-stored in step 101. Because object tracking in the video is carried, out on a frame basis, the image processing system extracts the image of the corresponding frame from the video and sets the RoI. When step 101 is the start of the object tracking, the RoI is the entire image.

In step 103, the image processing system extracts the RoI from the image. That is, as regions other than the RoI are not the target of the feature point search, the image processing system extracts only image information of the RoI.

In step 105, the image processing system extracts at least one feature point in the RoI. For example, the image processing system generates temporary images by modeling the image of the RoI in various scales, determines the feature point using the relation between the images, and then calculates a unique scale value for the corresponding feature point. Next, the image processing system generates an orientation and an edge histogram for a neighboring region of the feature point based on the calculated unique scale value, and determines a scriptor using the edge histogram.

For modeling in various scales, the image processing system generates blurred images by applying Gaussian filtering corresponding to each scale of the original image. The blurred images are the scale images. The resolution of the blurred images is substantially the same according to the original image and their blurring levels are different from each other. A Difference of Gaussian (DoG) image is generated from the blurring images and indicates the difference between the Gaussian-blurred images; that is, indicates a difference image. When a certain pixel between the difference images is greatest or smallest among adjacent 26 pixels in the three dimensions, the image processing system determines the corresponding point as the feature point and the scale of the corresponding feature point as the unique scale value. That is, the unique scale value indicates the scale of the region mostly clearly representing the region based on the corresponding feature point. Theoretically, as the resolution of the image varies, the absolute value of the scale also changes. Accordingly, the normalization makes them substantially the same. After determining the unique scale value, the image processing system selects a region around the feature point based on the unique scale value, normalizes the selected region with a certain resolution, and calculates the orientation by calculating a gradient in x and y directions per pixel of the normalized image. In doing so, the image processing system quantizes 360 degrees to 36, determines the histogram of the orientation for every pixel, and then determines the direction of the highest value as the orientation of the corresponding region. To calculate the edge histogram, the image processing system quarters the corresponding region by 2×2, determines the quantized direction per pixel in the eight directions by calculating the gradient of the x and y directions per pixel, and constitutes the whole histogram using them. To recognize the two images, the image processing system extracts the orientation and the edge histogram for the feature point and the neighboring region of each image. The image processing system obtains pairs of the similar feature points by comparing the edge histograms for the feature point extracted from the two images, and calculates similarity of the two images using the pairs. Because the high similarity signifies high probability of being the same object in the two images, the image processing system determines the recognition.

In step 107, the image processing system compares the at least one extracted feature point with predefined feature points of the target object. That is, the image processing system pre-stores feature point information of the target object and determines the existence of the image of the target object by comparing, the pre-stored feature point of the target object with the feature point extracted from the image.

In step 109, the image processing system extracts the pose information. For example, the pose information includes a transform matrix of the at least one extracted feature point.

In step 111, the image processing system estimates the pose using the pose information. For example, the image processing system can estimate the pose using a robust filtering scheme with a Kalman filter, a particle filter, and such. The Kalman filter predicts optimal data through a recursive computation using past and current data. According to the Kalman filter, the image processing system estimates the optimal pose through the recursive computation using past pose information and current pose information. The particle filter estimates information of the system by inputting a plurality of data randomly generated with a probability distribution adequately proposed to the system and analyzing the data overall. According to the particle filter, the image processing system, inputs a plurality of data randomly generated with a probability distribution corresponding to the pose information, analyzes the data overall, and thus estimates the pose.

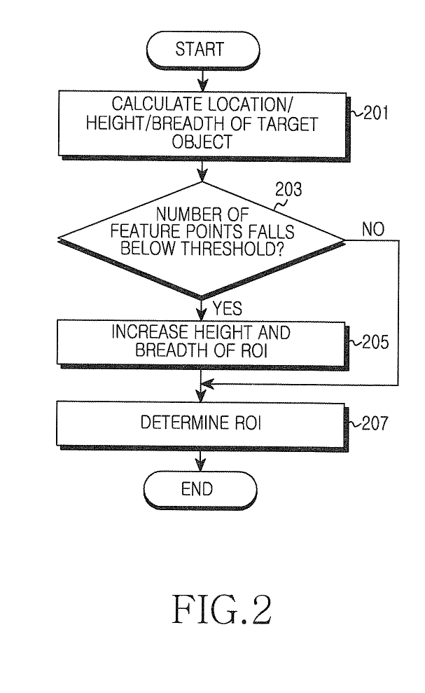

In step 113, the image processing system sets the RoI for the object tracking in a next frame image. The image processing system sets the RoI using the pose estimated in the step 111. More specifically, the RoI is set as shown in FIG. 2. Referring to FIG. 2, the image processing system calculates a location, a height, and a breadth of the target object in the image using the estimated pose in step 201. Herein, the region covering the location, the height, and the breadth of the target object is initially set to the RoI. In step 203, the image processing system determines whether the number of the extracted feature points is smaller than a threshold. When the number of the extracted feature points exceeds the threshold, the image processing system increases the height and the breadth of the RoI in step 205. When determining that the number of the extracted feature points falls below the threshold in step 203 or after increasing the height and the breadth of the RoI in step 205, the image processing system determines the region of the calculated location, height, and breadth or of the increased height and breadth as the ROI in step 207.

In step 115, the image processing system estimates the RoI. The image processing system estimates the RoI in a similar manner to the pose estimation. For example, the image processing system can estimate the RoI using the robust filtering scheme with the Kalman filter or the particle filter. That is, to estimate the RoI, the image processing system uses the x and y locations, the height, and the breadth of the RoI as the input data of the Kalman filter and estimates the next RoI according to the Kalman filtering result.

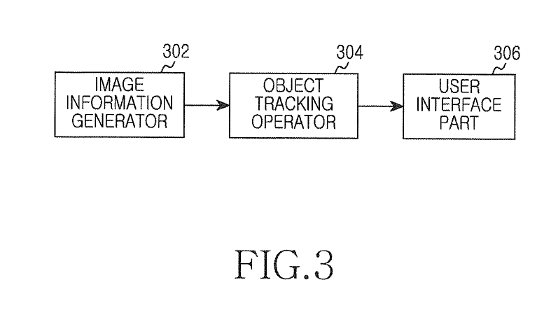

FIG. 3 is a block diagram of an image processing system according to an embodiment of the present invention.

The image processing system of FIG. 3 includes an image information generator 302, an object tracking operator 304, and a user interface part 306.

The image information generator 302 generates image information from the image input through the camera or the pre-stored video, and provides the generated image information to the object tracking operator 304.

The object tracking operator 304 tracks the target object in the image fed from the image information generator 302. In an embodiment of the present invention, the object tracking operator 304 uses the RoI, sets the RoI using the estimated pose, modifies the RoI using the number of the searched feature points, and estimates the RoI using the filtering scheme. More specifically, the object tracking operator 304 sets the entire initial image to the RoI and extracts the feature points in the RoI. For example, the object tracking operator 304 generates the images by modeling the image of the RoI in various scales, determines the feature points using the relation between the images, calculates the unique scale value for the corresponding feature point, generates the edge histogram for the neighboring region of the feature point based on the calculated unique scale value, and determines the feature point using the edge histogram. After extracting the feature points, the object tracking operator 304 determines the existence of the image of the target object by comparing the at least one extracted feature point with the predefined feature points of the target object, extracts the pose information, and estimates the pose based on the pose information using the Kalman filter or the particle filter. Next, the object tracking operator 304 sets the RoI for the object tracking in the image of the next frame. In doing so, the object tracking, operator 304 calculates the location, the height, and the breadth of the target object in the image using the estimated pose, and increases the height and the breadth of the RoI when the number of the extracted feature points exceeds the threshold. Next, the object tracking operator 304 estimates the RoI using the Kalman filter or the particle filter. The object tracking operator 304 repeats the above process.

The user interface part 306 displays the object tracking result of the object tracking operator 304 in a manner recognizable by the user such that the user can perceive it. For example, the user interface part 306 can display a mark indicating the target object or a value indicating the tracking result of the target object together with the image. For example, the user interface part 306 can employ a Liquid Crystal Display (LCD), an Organic. Light Emitting Diode (OLED), and such.

As set forth above, to estimate the object in the image, the RoI is set using the pose information estimated with the robust method, thus improving the speed compared to the conventional methods. The set RoI is estimated again using the robust method to thus enhance the accuracy and the reliability for the RoI. Therefore, the accuracy and the reliability of the object tracking are elevated and thus the accurate pose can be estimated.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A method for tracking an object in an image, the method comprising:
extracting pose information using a relation of at least one feature point extracted in a first Region of Interest (Roe;
estimating a pose using the pose information;
setting a second RoI using the pose; and
estimating the second RoI using a filtering scheme.

2. The method of claim 1, wherein the relation of the at least one feature point comprises coordinates of the at least one feature point.

3. The method of claim 1, wherein estimating the pose comprises estimating the pose through a recursive computation using past pose information and current pose information.

4. The method of claim 1, wherein estimating the pose comprises estimating the pose by analyzing data generated according to a probability distribution corresponding to the pose information.

5. The method of claim 1, wherein setting the second RoI using the pose comprises:
calculating a location, a height, and a breadth of a target object in the image using the estimated pose;
setting a region covering the location, the height, and the breadth of the target object as the second RoI; and
when a number of extracted feature points exceeds a threshold, increasing at least one of the height and the breadth of the second RoI.

6. The method of claim 1, wherein the filtering scheme is one of a Kalman filter and a particle filter.

7. The method of claim 1, further comprising:
extracting at least one feature point in the first RoI; and
comparing the at least one feature point with feature points of a target object.

8. The method of claim 7, wherein extracting the at least one feature point comprises:
generating images by modeling an image of the first RoI in various scales;
determining a feature point using a relation between the images;
calculating a unique scale value for a corresponding feature point; and
generating an edge histogram for a neighboring region of the feature point based on the unique scale value.

9. An apparatus for tracking an object in an image, the apparatus comprising:
an image information generator configured to generate image information; and
an operator configured to extract pose information using a relation of at least one feature point extracted in a first Region of Interest (Roe, estimate a pose using the pose information, set a second RoI using the pose, and estimate the second RoI using a filtering scheme.

10. The apparatus of claim 9, wherein the relation of the at least one feature point comprises coordinates of the at least one feature point.

11. The apparatus of claim 9, wherein the operator is further configured to estimate the pose through a recursive computation using past pose information and current pose information.

12. The apparatus of claim 9, wherein the operator is further configured to estimate the pose by analyzing data generated according to a probability distribution corresponding to the pose information.

13. The apparatus of claim 9, wherein the operator is further configured to calculate a location, a height, and a breadth of a target object in the image using the estimated pose, set a region covering the location, the height, and the breadth of the target object as the second RoI, and increase at least one of the height and the breadth of the second RoI when a number of extracted feature points exceeds a threshold.

14. The apparatus of claim 9, wherein the filtering scheme is one of a Kalman filter and a particle filter.

15. The apparatus of claim 9, wherein the operator is further configured to extract at least one feature point in the first RoI, and compare the at least one feature point with feature points of a target object.

16. The apparatus of claim 15, wherein, to extract the at least one feature point, the operator is further configured to generate images by modeling an image of the first RoI in various scales, determine a feature point using a relation between the images, calculate a unique scale value for a corresponding feature point, and generate an edge histogram for a neighboring region of the feature point based on the unique scale value.

17. A system comprising:
an image processing, system configured to extract pose information using a relation of at least one feature point extracted in a first Region of Interest (Roe, estimate a pose using the pose information, set a second RoI using the pose, and estimate the second RoI using a filtering scheme.

18. The system of claim 17, wherein the relation of the at least one feature point comprises coordinates of the at least one feature point.

19. The system of claim 17, wherein the image processing system is further configured to estimate the pose through a recursive computation using past pose information and current pose information.

20. The system of claim 17, wherein, to set the second RoI using the pose, the image processing system is further configured to calculate a location, a height, and a breadth of a target object in the image using the estimated pose, set a region covering the location, the height, and the breadth of the target object as the second RoI, and increase at least one of the height and the breadth of the second RoI when a number of extracted feature points exceeds a threshold.
